(19) United States
(12) Patent Application Publication
(10) Pub. No.: US 2005/0123892 A1
(43) Pub. Date: Jun. 9, 2005

(54) Method, system and program product for developing and utilizing interactive simulation based training products

(76) Inventors: William A. Cornelius, Wilton, NY (US); Karen E. Cornelius, Wilton, NY (US); Stephen H. Gallay, Toronto (CA); Alethea J. Snyder, Voorheesville, NY (US)

Correspondence Address: Hoffman Warnick & D'Alessandro, Three E-Comm Square, Albany, NY, 12207, US

(21) Appl. No.: 11/003,718

(22) Filed: Dec. 3, 2004

Related U.S. Application Data
(60) Provisional application No. 60/527,429, filed on Dec. 5, 2003.

(51) Int. Cl. G09B 23/28; G09B 19/00; G09B 7/00

(52) U.S. Cl. 434/323; 434/236; 434/262

(57) ABSTRACT

A method, system and program product for developing and utilizing interactive simulation based training products. Specifically, the invention gives a developer the ability to: create an environment for creating the training product; create and edit interactive objects that the user will be able to use to manipulate the environment; create and edit properties for these interactive objects, such as the size, shape and color of the objects; create and edit behaviors of the interactive objects that define the interactive object's ability to manipulate the environment; and create resources for instructing a user to perform a particular task. Interactive objects, environments, resources, chapters and entire training courses or templates may be imported into the training system from a set of libraries. Additionally, the developer may develop an evaluation system, a support materials system, and a previewer. The invention may also be used to create chapter based training programs.

### BACKGROUND OF THE INVENTION

1. Field of the Invention

In general, the present invention relates to computer based training products. Specifically, the present invention relates to a method, system and program product for developing and utilizing interactive simulation based training products.

2. Background Art

As computers become faster and more powerful, they are being used to do things once done only by humans. One way in which computers are currently being utilized is to train people in ways previously only done in the classroom. To do this, two types of training programs have been developed, namely chapter based training programs and simulation based training programs.

Chapter based training programs are best thought of in terms of a book. Like a book, chapter based training programs normally have text that is divided into chapters for the user to read. Periodically, during the training program, normally at the end of a chapter or section, the training program will test the progress of the user, such as with the use of quizzes and tests. Additionally, during the chapter based program, the user may be asked to perform minor tasks such as click a portion of a screen, such as a control button, with a mouse or to type text into a text box. The chapter based type of training program is suited for teaching tasks but is not optimal teaching tasks for which visualization skills are required.

In contrast, a simulation based training program allows a user to visualize the steps of a particular procedure. The training program may include tools or “objects” for performing a task, a workspace for performing the task in, and resources giving the user instructions for performing the task. The training program may also run a demonstration of the task to be run to allow the user to see how it is performed. The user is then allowed to select an object and use the object to perform a certain task on the screen. For example, a person that is training to be a surgeon may select a scalpel object to make an incision on a virtual patient or a mechanic may select a wrench object to loosen a virtual bolt.

One shortcoming in the art has been the lack of tools for creating training programs, especially interactive simulation based training programs. These programs may be very time consuming to create from scratch. As a result, the use of these training programs may be underutilized.

In view of the foregoing, there exists a need for a method, system and program product for developing and utilizing interactive simulation based training products. Additionally, it would be advantageous if the same tool were able to used to develop chapter based training products.

### SUMMARY OF THE INVENTION

In general, the present invention provides a method, system and program product for developing and utilizing interactive simulation based training products. Specifically, the invention gives a training products developer the ability to: create an environment in which the training product is to be created; create and edit interactive objects that the user will be able to use to manipulate the environment; create and edit properties for these interactive objects, such as the size, shape and color of the objects; create and edit behaviors of the interactive objects that define the interactive object's ability to manipulate the environment; and create resources for instructing a user to perform a particular task. Interactive objects, environments, resources, chapters and entire training courses or templates may be imported into the training system from a set of libraries. Additionally, the developer may develop an evaluation system to measure the progress of the user. Furthermore, the developer may develop a support materials system for providing support materials such as a glossary to the user. The invention may also include a previewer that allows the developer to see the training program that has been created. The invention may also be used to create chapter based training programs and to add simulations to chapter based training programs.

A first aspect of the present invention provides a system for developing interactive simulation-based training courses, the system comprising: an initializer for initializing an environment for developing an interactive simulation-based training course; an object provider for providing at least one interactive object for use in the environment; an object property editor for editing a property of the at least one interactive object; an object behavior editor for editing a behavior of the at least one interactive object; and a training course resource editor for editing resources associated with the interactive simulation-based training course.

A second aspect of the present invention provides a computer implemented method for developing interactive simulation-based training courses, the method comprising: initializing an environment for developing an interactive simulation-based training course; providing at least one interactive object to be placed in the environment; editing a property of the at least one interactive object; editing a behavior of the at least one interactive object; and editing resources associated with the interactive simulation-based training course.

A third aspect of the present invention provides a program product stored on a recordable medium for developing interactive simulation-based training courses, which when executed, comprises: program code configured to initialize an environment for developing an interactive simulation-based training course; program code configured to provide at least one interactive object for use in the environment; program code configured to edit a property of the at least one interactive object; program code configured to edit a behavior of the at least one interactive object; and program code configured to edit text associated with the interactive simulation-based training course.

A fourth aspect of the present invention provides a method for deploying an application for developing interactive simulation-based training courses, comprising: providing a computer infrastructure being operable to: initialize an environment for developing an interactive simulation-based training course; provide at least one interactive object for use in the environment; edit a property of the at least one interactive object; edit a behavior of the at least one interactive object; and edit text associated with the interactive simulation-based training course.

A fifth aspect of the present invention provides computer software embodied in a propagated signal for developing interactive simulation-based training courses, the computer software comprising instructions to cause a computer system to perform the following functions: initialize an environment for developing an interactive simulation-based training course; provide at least one interactive object for use in the environment; edit a property of the at least one interactive object; edit a behavior of the at least one interactive object; and edit text associated with the interactive simulation-based training course.

Therefore, the present invention provides a method, system and program product for creating and utilizing interactive simulation-based interactive training programs.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a block diagram of a computer system having a system for creating and utilizing interactive simulation-based training programs in accordance with the present invention;

FIG. 2 depicts a box diagram of one embodiment of a system for creating and utilizing interactive simulation-based interactive training programs of FIG. 1;

FIG. 3 depicts a box diagram of one embodiment of the libraries of FIG. 1;

FIG. 4 depicts a screenshot of an environment according to one embodiment of the invention;

FIGS. 5 depicts a screenshot of an opening screen in existing simulation mode according to one embodiment of the invention;

FIGS. 6 depicts a screenshot of an opening screen in new simulation mode according to one embodiment of the invention;

FIG. 7 depicts a screenshot of a course specific information screen that allows a developer to input or modify course information according to one embodiment of the invention;

FIG. 8 depicts a screenshot of a course editor screen that allows a developer to create or modify a course or course step according to one embodiment of the invention;

FIG. 9 depicts a screenshot of add-edit pop-up window for creating and editing information about a particular step according to one embodiment of the invention;

FIG. 10 depicts a screenshot of a material views screen for creating and editing interactive objects according to one embodiment of the invention;

FIG. 11 depicts a screenshot of an environment development screen for creating and editing an environment according to one embodiment of the invention;

FIG. 12 depicts a screenshot of a background question box for use in creating and editing an environment according to one embodiment of the invention;

FIG. 13 depicts a screenshot of a correct/incorrect popup screen for creating and editing information regarding correct and incorrect responses according to one embodiment of the invention;

FIG. 14 depicts a screenshot of a navigation popup screen for defining functions for control buttons according to one embodiment of the invention;

FIG. 15 depicts a screenshot of a quiz/test editor screen for creating and editing quizzes and tests according to one embodiment of the invention;

FIG. 16 depicts a screenshot of a course credit screen for creating and editing a system for assessing credit according to one embodiment of the invention;

FIG. 17 depicts a screenshot of a glossary screen for specifying glossary-type support materials according to one embodiment of the invention;

FIG. 18 depicts a screenshot of a tabs screen for specifying tabs-type support materials according to one embodiment of the invention;

FIG. 19 depicts a screenshot of a vignettes screen for specifying vignettes-type support materials according to one embodiment of the invention; and

FIG. 20 depicts a method flow chart according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE DRAWINGS

In general, the present invention provides a method, system and program product for developing and utilizing interactive simulation based training products. Specifically, the invention gives a training products developer the ability to: create an environment in which the training product is to be created; create and edit interactive objects that the user will be able to use to manipulate the environment; create and edit properties for these interactive objects, such as the size, shape and color of the objects; create and edit behaviors of the interactive objects that define the interactive object's ability to manipulate the environment; and create resources for instructing a user to perform a particular task. Interactive objects, environments, resources, chapters and entire training courses or templates may be imported into the training system from a set of libraries. Additionally, a developer may develop an evaluation system to measure the progress of the user. Furthermore, the developer may develop a support materials system for providing support materials such as a glossary to the user. The invention may also include a previewer that allows the developer to see the training program that has been created. The invention may also be used to create chapter based training programs and to add simulations to chapter based training programs.

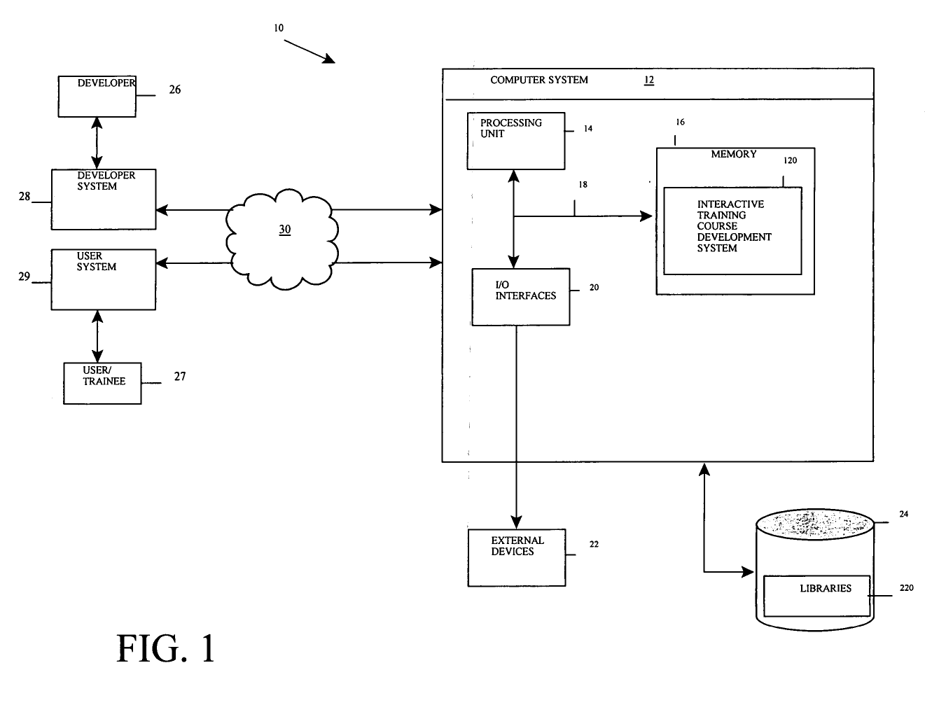

Referring now to FIG. 1, a system for creating and utilizing interactive simulation-based training programs 10 according the present invention is shown. As depicted, computer system 12 is provided, which is intended to represent any type of computer system capable of carrying out the teachings of the present invention. For example, computer system 12 can be a desktop computer, a laptop computer, a workstation, a handheld device, a client, a server, etc. In any event, the teachings of the present invention can be implemented via a stand-alone system, or over a network 30 (as shown) such as the Internet, a local area network (LAN), a wide area network (WAN), a virtual private network (VPN), etc. In the case of the latter, communication throughout the network could occur via a direct hardwired connection (e.g., serial port), or via an addressable connection that may utilize any combination of wireline and/or wireless transmission methods. Conventional network connectivity, such as Token Ring, Ethernet, WiFi or other conventional communications standards could be used. Still yet, connectivity could be provided by conventional IP-based protocol. In this instance, an Internet service provider could be used to establish interconnectivity.

In communicating with computer system 12 over network 30 developer 26 and user/trainee 27 can operate separate computer systems 28 and 29 (e.g., in a client-server environment). In this case, the computer systems 28 and 29 can be any type of computerized device capable of communicating over a network (e.g., desktop computer, a laptop computer, a workstation, a handheld device).

As further shown, computer system 12 generally includes processing unit 14, memory 16, bus 18, input/output (I/O) interfaces 20, external devices/resources 22 and storage unit 24. Processing unit 14 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Moreover, similar to processing unit 14, memory 16 may reside at a single physical location, comprising one or more types of data storage, or be distributed across a plurality of physical systems in various forms.

I/O interfaces 20 may comprise any system for exchanging information to/from an external source. External devices/resources 22 may comprise any known type of external device, including speakers, a CRT, LED screen, hand-held device, keyboard, mouse, voice recognition system, speech output system, printer, monitor/display, facsimile, pager, etc. Bus 18 provides a communication link between each of the components in computer system 12 and likewise may comprise any known type of transmission link, including electrical, optical, wireless, etc.

Storage unit 24 can be any type of system (e.g., a database) capable of providing storage for information (e.g., templates, simulations, libraries 200, etc.) under the present invention. As such, storage unit 24 could include one or more storage devices, such as a magnetic disk drive or an optical disk drive. In another embodiment, storage unit 24 includes data distributed across, for example, a local area network (LAN), wide area network (WAN) or a storage area network (SAN) (not shown). Although not shown, additional components, such as cache memory, communication systems, system software, etc., may be incorporated into computer system 12.

Shown in memory 16 of computer system 12 is an interactive training course development system 120 (shown in FIG. 1 as a software product). Interactive training course development system 120 will be described in more detail below but generally comprises a method and system for developing interactive simulation-based training programs on computer system 12. Specifically, interactive training course development system 120 allows a developer 26 to create a training program that includes one or more simulations that allow a user/trainee 27 to interact with the environment. The training program created with interactive training course development system 120 may include one or more steps that allow user/trainee 27 to use one or more interactive objects to manipulate an item in an environment to accomplish a task.

Shown in storage unit 24 of computer system 12 is libraries 220. Libraries 220 will be described in more detail below but generally comprises one or more resources that may be imported into computer system 12 for use with interactive training course development system 120. Specifically, developer 26 may import resources from libraries 220 and may use the imported resources to create, modify or utilize a training program with interactive training course development system 120. Such resources could include, inter alia: (1) courses, (2) templates, (3) images, (4) motions, (5) animations, (6) audio clips, (7) video clips, and (8) action scripts. Libraries 220 may include one or more databases/storage devices, such as a magnetic disk drive or an optical disk drive. In another preferred embodiment libraries 220 include data distributed across, for example, a local area network (LAN), wide area network (WAN) or a storage area network (SAN) (not shown). Libraries 220 may also be configured in such a way that one of ordinary skill in the art may interpret it to include one or more storage devices.

It should be appreciated that the present invention could be offered as a business method on a subscription or fee basis. For example, computer system 12, including interactive training course development system 120, etc. could be created, supported, maintained and/or deployed by a service provider that offers the functions described herein for customers. That is, a service provider could offer to implement interactive training course development system 120 with or without libraries 220 as components for customers.

It should also be understood that the present invention could be realized in hardware, software, a propagated signal, or any combination thereof. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

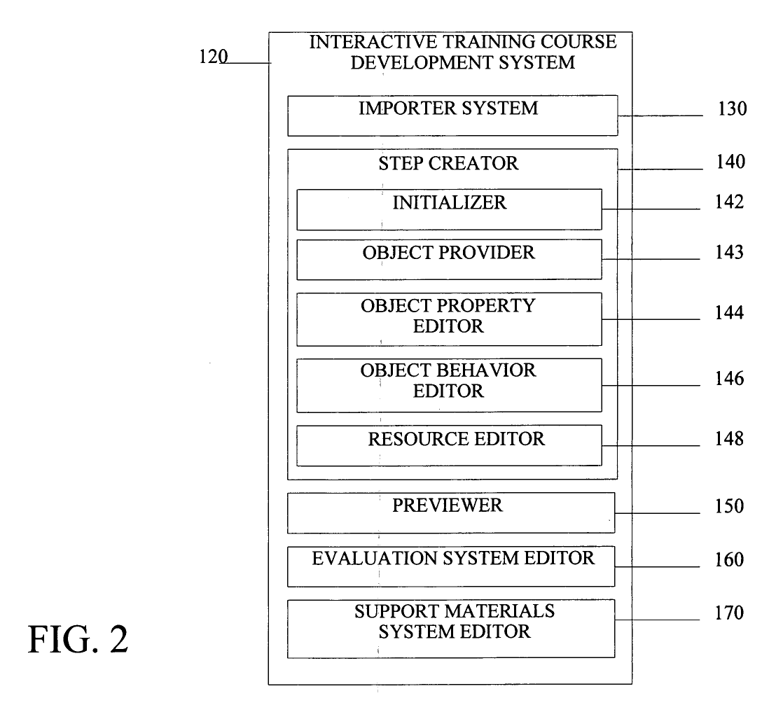

Referring now to FIG. 2, interactive training course development system 120 is shown in greater detail. As depicted, interactive training course development system 120 generally includes importer system 130, step creator 140, previewer 150, evaluator system 160, and support materials system 170. Importer system 130 provides a way for developer 26 to import a resource from libraries 220 (FIG. 1). As stated above the resources that importer system 130 may import from libraries 220 may include, inter alia, a course, a template, an image, a motion, an animation, an audio clip, a video clip and an action script. Developer 26 (FIG. 1) may use the resource imported using importer system 130 to include in a created training program, may use the imported resource as a basis for the training program to be created, or may modify a previously created imported resource to produce a training program, among other uses.

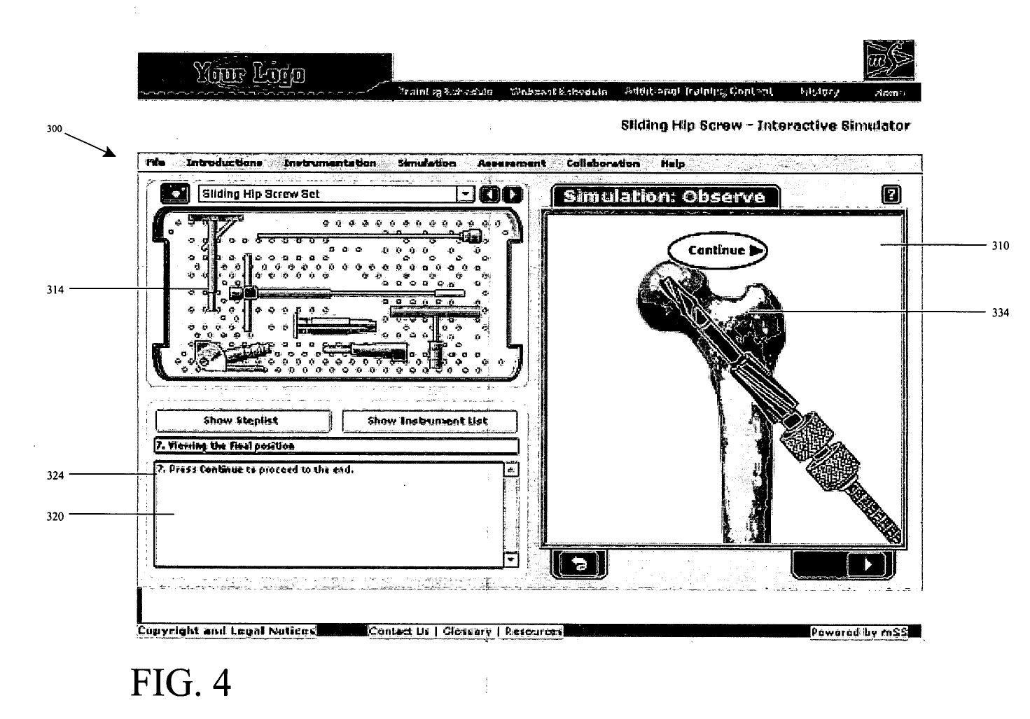

Step creator 140 provides a way for developer 26 to create one or more steps in an interactive simulation-based training program. Step creator 140 may include an initializer 142, an object provider 143, an object property editor 144, an object behavior editor 146, and a resource editor 148. Initializer 142 allows developer 26 to initialize an environment 300 (FIG. 4) for developing an interactive simulation-based training course. Referring to FIG. 4, environment 300 may include an object positioning area 310 into which at least one interactive object 314 may be placed for manipulation by user/trainee 27. Environment 300 may also include a resource area 320 for displaying resources 324 for performing a task. Resources 324 may include text, illustrations, instructions or any other resources 324 necessary to be displayed for performing a task. Environment 300 may also include a work area 330 in which user/trainee 27 (FIG. 1) may perform a task. Initializer 142 (FIG. 2) may provide a way for developer 26 to place one or more items 334 in work area 330 of environment 300 upon which user/trainee 27 may perform a task using interactive object 314. Object positioning area 310, resource area 320 and work area 330 may be three distinct areas as indicated in FIG. 4, or two or more of the areas may be merged into a single area. Additionally, a particular environment 300 may have a single object positioning area 310, resource area 320 and work area 330; may have more than one of any one area; or may have one or more of the areas absent from environment 300.

Referring now to FIGS. 2 and 4 collectively, step creator 140 may also include object provider 143 for providing at least one interactive object 314 (FIG. 4) for use in the environment. Object provider 143 may allow developer 26 to create an interactive object from scratch. In the alternative, object provider 143 may allow developer 26 to import an interactive object 314 into interactive training course development system 120 from libraries 220 (FIG. 1) of computer system 12. Object provider 143 may also allow developer 26 to position interactive object 314 in environment 300 (FIG. 4), such as in object positioning area 310. Positioning may be accomplished by drag-and-drop, menu, selection box, arrow keys, touch screen, radio box or any other method of positioning an object in computer system 12 now known or later developed. Positioning provided by object provider 143 may also include rotating interactive object 314. Furthermore, object provider 143 may be used to delete an object from environment 300.

Step creator 140 may also include object property editor 144 editing a property of interactive object 314. Property editor 144 may allow developer 26 to edit a property of interactive object 314 using a control button, computer code statement, selection box, drop-down menu, text box or any other way of defining a property now known or later developed. Examples of properties of interactive object 314 that may be defined or edited using property editor 144, include size, shape and color of interactive object, among others.

Step creator 140 may also include an object behavior editor 146 for editing a behavior of interactive object 314. Object behavior editor 146 allows developer 26 to define behaviors of interactive object 314 to, for example, allow user/trainee 27 to interact with interactive object 314. The behaviors defined by developer 26 using object behavior editor 146 may allow user/trainee 27 to use interactive object 314 to perform a task, such as by using interactive object 314 to operate on or to manipulate item 334 in work area 330 of environment 300. Behaviors of interactive object 314 defined using object behavior 146 may include, for example, behavior when chosen, behavior when dropped, behavior when moved, behavior when rotated, behavior when used to operate upon another interactive object 146, behavior when used to operate upon item 334 in work area 330, behavior when an action is performed successfully and behavior when an action is performed unsuccessfully.

Step creator 140 may also include training course resource editor 148 for editing resources 324 associated with the interactive simulation-based training course. Resource editor 148 may be used by developer 26 to place resources 324 in resource area 320 or in any other area of environment 300 where resources may be placed. As stated above resources 324 that are created or modified using resource editor 148 may include instructions for performing a task, for example, by instructing user/trainee 27 to pick up interactive object 314 and to use interactive object 314 in a specific way to operate on or to manipulate item 334 in work area 330 of environment 300.

Step creator 140 may be used to create or edit one or more steps in a training program. Steps created by step creator 140 may be in a series, such that a particular step may not be performed until a pre-determined previous step is completed. In the alternative, a developed may use step creator 140 to create steps such that a number of steps may be independent of each other, any of which may be performed by user/trainee 27. Interactive objects 314 in one step may be the same or different from those in another step. Likewise, items 334 in work area 330 of one step may be the same or different from those in another step. In addition, resources 324 in one step may be the same or different from those in another step. Furthermore, at least one of environment 300, interactive objects 314 and resources 324 in a first step may differ from those in a second step. Step creator 140 may also be used by developer 26 to delete a step, indent a step, outdent a step, and move a step up or down in a step progression, among other things.

As indicated above, training course development system 120 may also include previewer 150. Previewer 150 may allow developer 26 to execute a portion of a training course that has been imported from libraries 220 of computer system 12 (FIG. 1), modified by developer using interactive training course development system 120, or created by developer 26 using interactive training course development system 120. Previewer 150 may allow developer 26 to execute one or more steps that have been created or edited using step creator 140. In contrast, previewer 150 may allow developer 26 to execute a portion of a step or an entire training program. Previewer 150 may allow developer 26 to observe the execution with all tasks being performed automatically. In observation mode, the execution performed by previewer 150 may be uninterrupted or may require some periodic response, such as a keystroke or mouse button press. Conversely, previewer 150 may allow developer 26 to actually perform the required tasks specified by resources 324, such as by using interactive object 314 to perform a task on item 334.

Training course development system 120 may also include an evaluation system editor 160 that allows developer 26 to create or modify evaluation criteria for evaluating the progress of user/trainee 27. Evaluation criteria created by developer 26 using evaluation system editor 160 may include tests or quizzes that periodically evaluate the knowledge of user/trainee 27. Additionally, evaluation criteria created by evaluation system editor 160 may include monitoring tasks performed as part of a step to determine, for example, length of time or number of tries required to perform the step. Developer 26 may also use evaluation system editor 160 to give feedback to user/trainee 27, including, but not limited to, providing a message when a task is performed or test or quiz question is answered correctly or incorrectly. The message may include text, audio, image, video, or any other way of providing a message now known or later developed. Evaluation system editor 160 may also be used by developer 26 to provide a grade to user/trainee 27. The grade provided to user/trainee 27 may reflect any of the above stated evaluation criteria or any other factors that developer 26 deems necessary to provide a meaningful grade. In addition, if the grade given in the course exceeds a particular threshold, developer 26 may use evaluation system editor 160 to give credit for completing an interactive simulation-based training course. The credit may be stored as a part of a training profile that pertains to a particular user, a group to which user/trainee 27 belongs or any other meaningful method of tracking course credit.

Training course development system 120 may also include a support materials system editor 170 for allowing developer 26 to provide support materials for user/trainee 27 to use in conjunction with the training course. Developer 26 may use support materials system editor 170 to manage a glossary of terms that may be useful to user/trainee 27. Support materials system editor 170 may allow developer 26 to create a term, modify a previously created or imported term, or delete a term, among other things. Developer 26 may designate that terms created using supports materials system editor 170 are accessed by user/trainee 27 through hyperlinks from resources in the environment, menus, tabs, a popup box, or any other desired method of access.

Support materials system editor 170 may also allow developer 26 to create vignettes to be viewed by user/trainee 27. Vignettes created using support materials system editor 170 may include a grouping of Hypertext Markup Language (HTML) pages that form a sequence of information to be viewed when the trainee selects a vignette-type menu item from a tab in the training course. Types of vignettes that may be created using support materials system editor 170 include, but are not limited to, vignettes that are created to be assigned by developer 26 to a specific tab menu item; a welcome vignette that will automatically pop up when a trainee opens a training course; and a congratulations vignette that will automatically popup when a trainee has completed a course. Support materials system editor 170 may also be used to edit previously created or imported vignettes or to delete vignettes.

Support materials system editor 170 also may allow developer 26 to create tabs that allow user/trainee 27 to navigate within the training course. Specific tabs may include, inter alia, an exit tab for exiting the training course; a vignette tab for displaying an appropriate vignette; a materials tab for displaying interactive objects 314, items 334 and other materials used in the course; an observe tab for allowing user/trainee 27 to watch a portion of the training course while the software takes the trainee trough all of the content and animation of that portion; a perform tab for allowing user/trainee 27 to perform tasks specified by the training course; an assessment tab for allowing user/trainee 27 to select a list of the assessments that will be accessible to the trainee at any time during the course; and an external file tab that allows user/trainee 27 to browse accessible files in the system, such as course related PDF documents. The elements accessed by each of these tabs may also be created or modified using materials system editor 170.

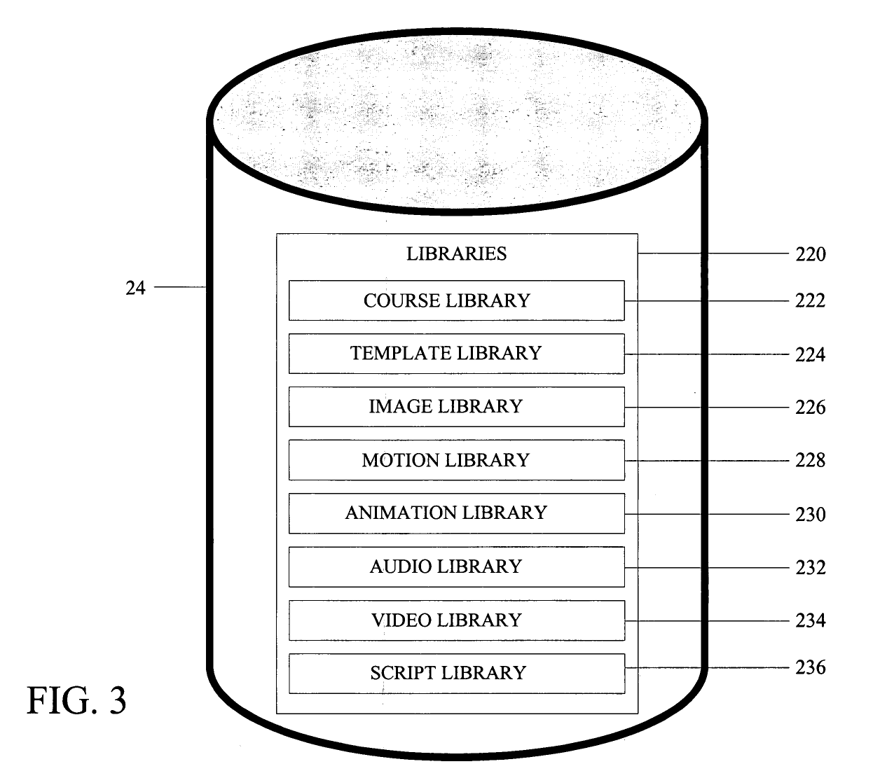

Referring now to FIG. 3, libraries 220 are shown in greater detail. As depicted, libraries 220 generally includes a course library 222, a template library 224, an image library 226, a motion library 228, an animation library 230, an audio library 232, a video library 234, and an script library 236. It is to be understood that the above list of libraries is not meant to be limiting, but merely illustrative, and that other types of libraries may be included as needed. Course library 222 includes training courses that have already been developed and that are available for modification and use. Course library 222 may include training courses for a single customer, a customer group, a specific area, or a combination of multiple customers, groups or areas, among other things. Template library 224 includes templates that reflect the look and feel of the web pages that developer 26 can select for a simulation or conventional course. Templates imported from template library 224 may then be modified and enhanced by developer 26 using interactive training course development system 120 to produce a completed training program. Image library 226 includes all images used by all courses, including backgrounds, logos, materials, work area items, etc.

Libraries 220 may also include motion library 228, which includes a set of functions that generate a specific motion. These functions may be applied to materials of the training course, including, but not limited to interactive objects 314 and items 334. Functions in motion library 228 may be written in Java to product a Java Script/Action Script, or in any other protocol with which this type of function may be specified. Animation library 230 stores and enables retrieval of more complex animation sequences than those in motion library 228. Animations imported from animation library 230 may be used in the same or different manner as the motions imported from motion library 228 and may be written in any appropriate language.

Libraries 220 may also include audio library 232, which includes audio clips that can be assigned to any course step or motion. Likewise, video library 234 includes video clips that can be assigned to any course step. Furthermore, script library 236 includes pre-defined action scripts used to implement standard functions selectable by a course developer.

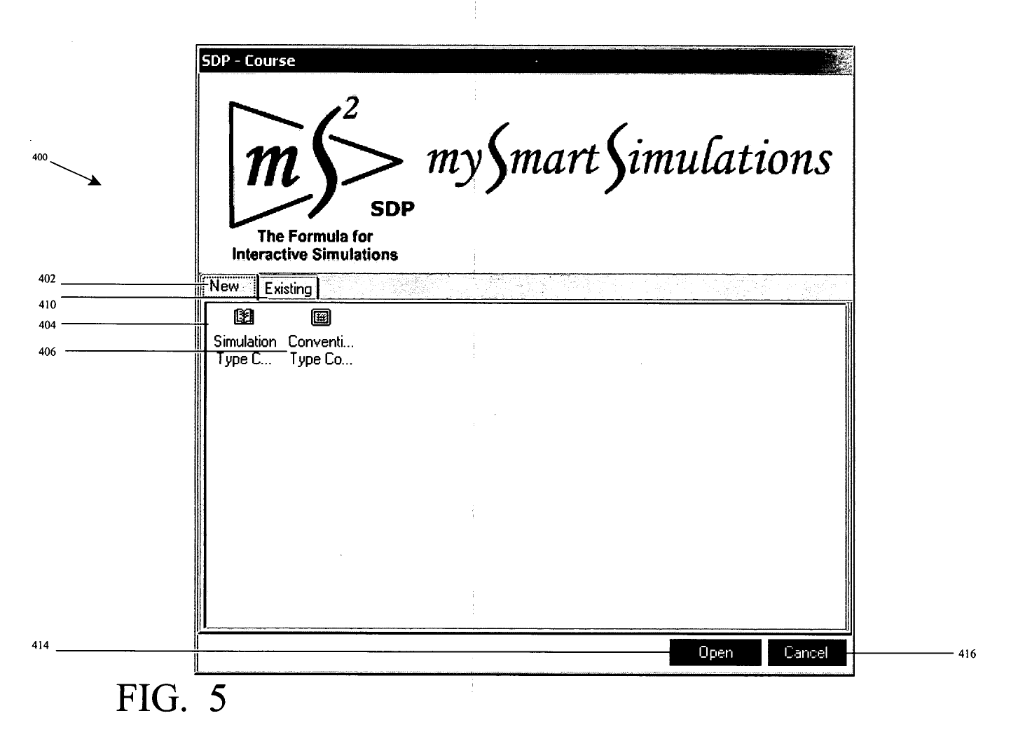

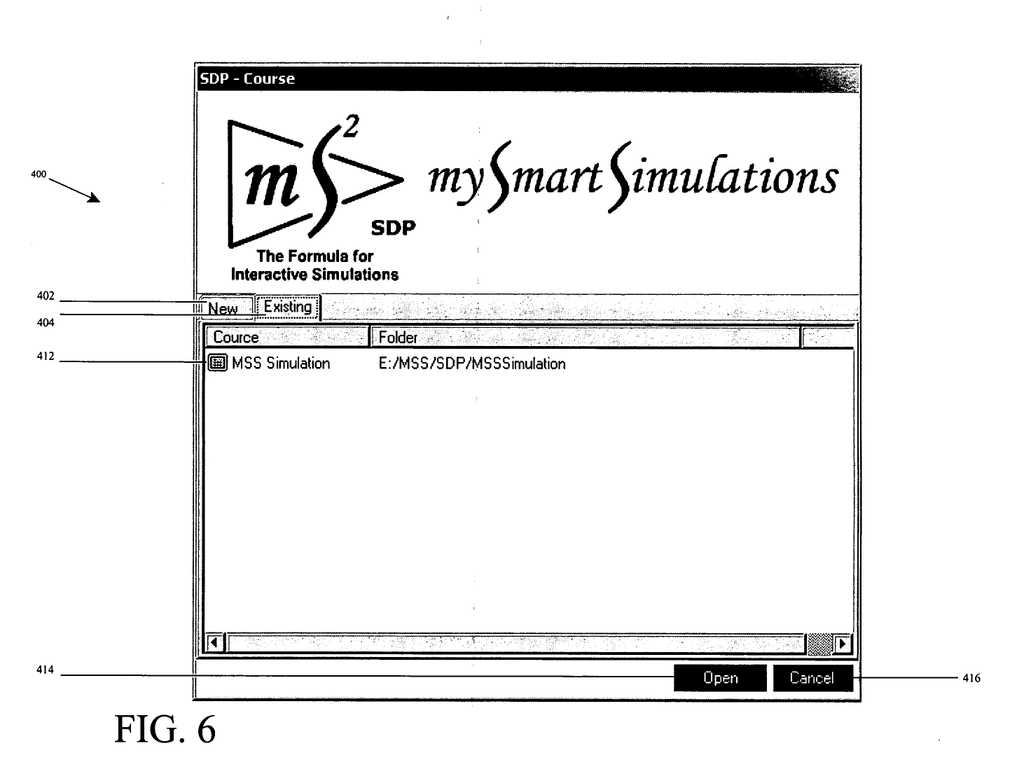

FIGS. 5-19 provide examples of one embodiment of the creation of an interactive simulation-based training course using interactive training course development system 120. FIGS. 5-6 depict a screenshot of an opening screen 400 according to one embodiment of the invention. Opening screen 400 has a new tab 402 that allows developer 26 to create a new training course. When new tab 402 is activated, such as in FIG. 5, developer 26 may choose the type of source to be created, such as simulation type course 404 and conventional type course 406. Opening screen 400 also has an existing tab 410, which when highlighted, as in FIG. 6, allows developer 26 to open an existing course such as MSS Simulation 412. In either new tab 402 or existing tab 410, an icon, such as simulation type course 404, conventional type course 406 (FIG. 5), or MSS Simulation 412 (FIG. 6), may be selected, such as by selecting the appropriate tab, highlighting the desired icon, and clicking on an open button 414. Opening screen 400 may also be closed using a cancel button 416.

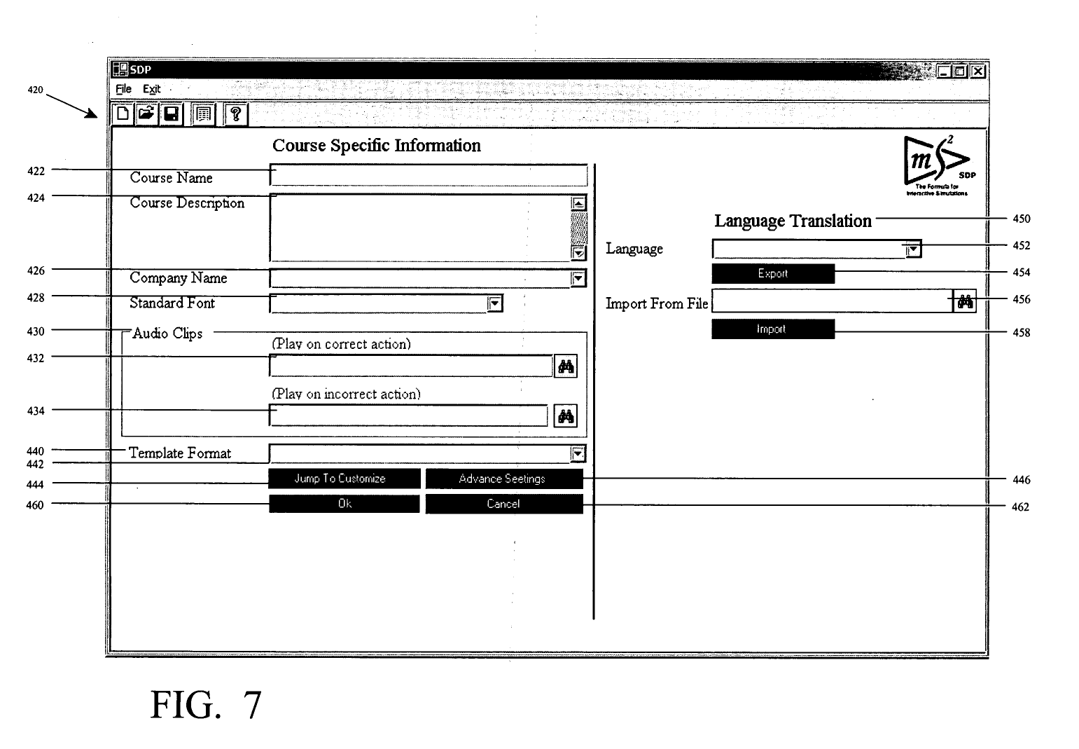

FIG. 7 depicts a screenshot of a course specific information screen 420 that allows developer 26 to input or modify course information according to one embodiment of the invention. Course specific information screen 420 includes a course name field 422 that allows developer 26 to input the official name for the course, a course description field 424 that allows developer 26 to input a brief description of the course, a company name field 426 that allows developer 26 to select the company name for which the course is being developed from a drop down list, and a default font field 428 that allows developer 26 to select a default font that is to be used for the course. Course specific information screen 420 also allows developer 26 to use an audio clip selection area 430 to select audio clips to be used in the course. Audio clip selection area 430 may include a play on correct action clip 432, which specifies the audio clip to be played if a correct action is taken by user/trainee 27, and a play on incorrect action clip 434, which specifies the audio clip to be played if an incorrect action is taken by user/trainee 27.

Course specific information screen 420 also includes a template format area 440 that allows developer 26 to specify template format options. Specifically, developer 26 may specify a template format type using a template format type pull down menu 442, may access a browser format template customization screen to enable developer 26 to select and customize a template from template library 224 of libraries 220 using a jump to customize button 444, or may access advanced settings for the course, such as certain flash settings (e.g. number of frames, etc) using an advance settings button 446.

Course specific information screen 420 may also include a language translation area 450 to facilitate the translation of a training course into another language. The translation may be accomplished by specifying the language using a language selector 452, exporting file using export button 454, selecting the file to import using import file browser 456, and importing the file using import button 458.

Upon completion of the information on course specific information screen 420, developer 26 may continue by pressing an OK button 460 of may cancel the process by pressing a cancel button 462.

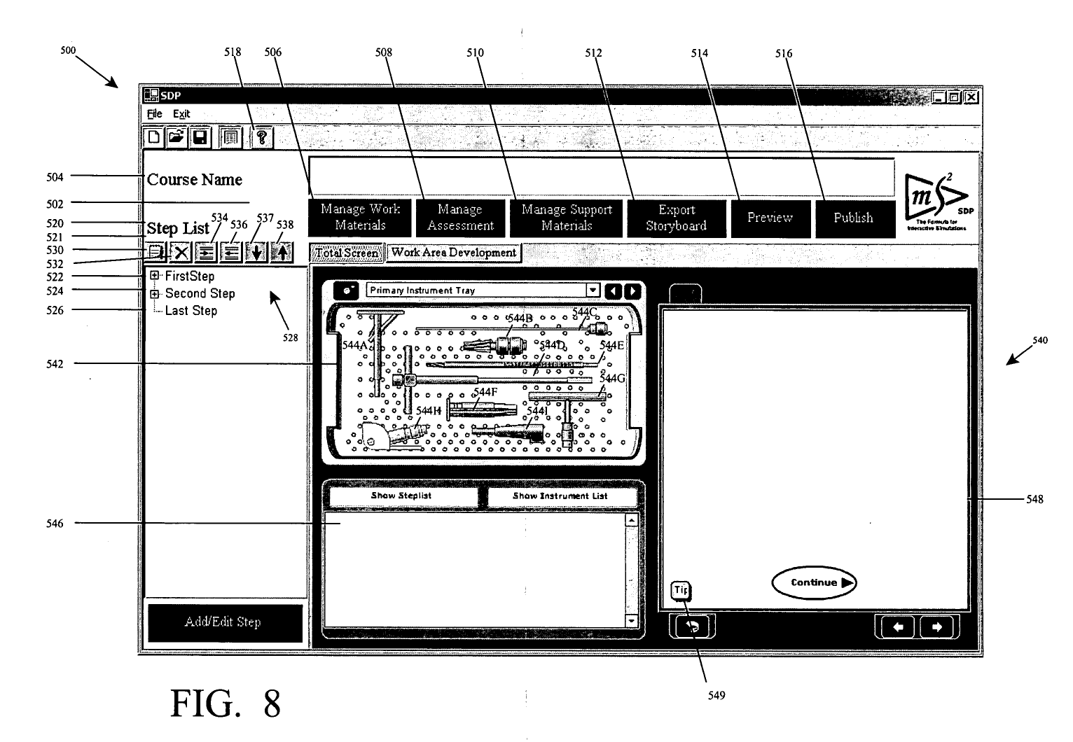

FIG. 8 depicts a screenshot of a course editor screen 500 that allows developer 26 to create or modify a course or course step according to one embodiment of the invention. As shown, course editor screen 500 includes a menu area 502. Menu area 502 includes a course name field 504 that displays the course that was selected or created in the previous pop-up window. Menu area 502 also includes a number of control buttons, including, but not limited to, a manage work materials button 506 that will take developer 26 to a screen where the materials area of the resulting course is developed; a manage assessment materials button 508 that will take developer 26 to a screen where the test, quizzes, evaluations, scoring, and credit information is established for the course; a manage support materials button 510 that will take developer 26 to a screen where supporting data is added, such as definition of glossary terms, tabs on the resulting course template are created, and where vignettes are created that step the trainee through a sequence of information behind certain tab options; an export storyboard button 512 that will create a external document, such as, for example, a Word document or PDF document, of the course in its current form, and store it so that developer 26 can view it, email the document, and/or to print it; a preview button 514 that will create a temporary file of the course, showing whatever has been done so far, and will enable developer 26 to execute this file in the Flash environment; a publish button 516 that does the same thing as the preview button, except that it also creates the course library reference table record that facilitates access to the course from the learning center, and stores the official version of the course as a file, such as in course library 222 of libraries 220 (FIG. 3); and a help button 518 (? Icon) that enables developer 26 to access the help information for how to use the various features of interactive training course development system 120.

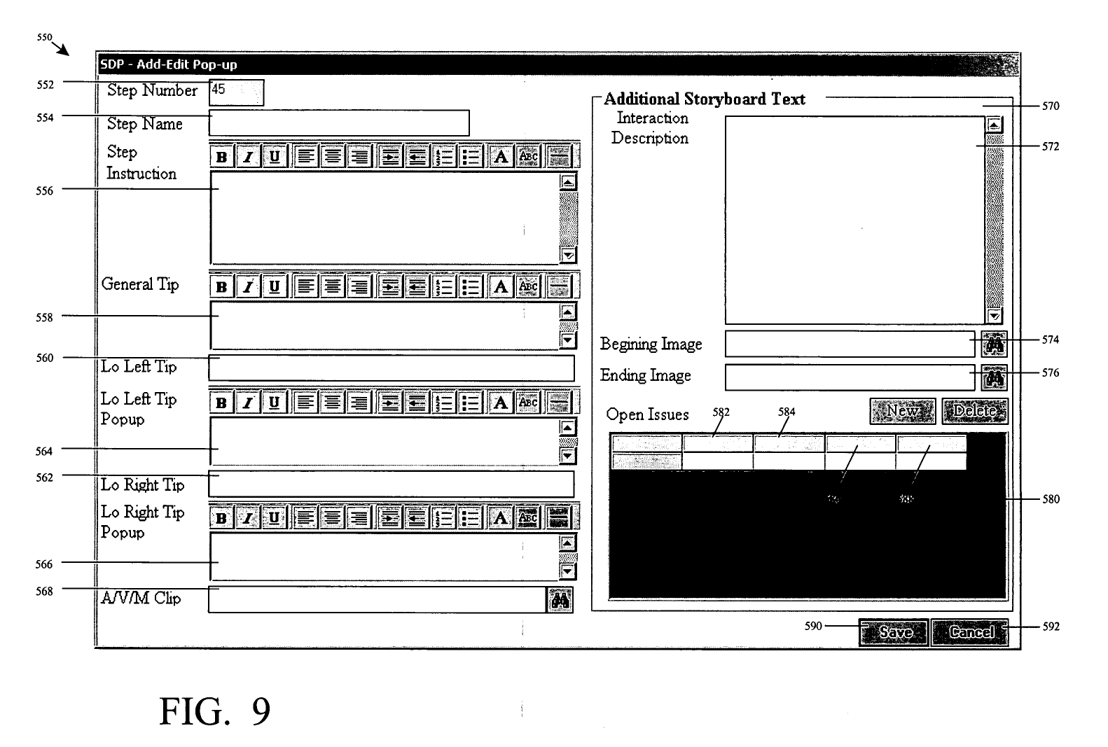

Course editor screen 500 also includes a step tree portion 520 where all of the step names are displayed, their content defined, and any substeps created in a similar manner. Step tree portion 520 includes a step list 521, which lists the steps in the training course such as First Step 522, Second Step 524 and Last Step 526. Step tree portion 520 also includes function buttons 528, which include copy button 530 for copying a step, delete button 532 for deleting a step, indent button 534 for indenting a step, outdent button 536 for outdenting a step, step up button 537 for moving a step up in the order, and step down button 538 for moving a step down in the order. When a specific step/substep is highlighted/selected, its current materials image, step content, and work area are displayed in step creation areas 540 on the right portion of the screen, where they can be edited or changed as needed. Step creation areas 540 include an object positioning area 542 into which object provider 143 (FIG. 2) positions at least one interactive object 544A-I, a resource area 546 for displaying resources (not shown) and a work area 548 for allowing user/trainee 27 to use interactive object 544A-I to perform a task. Work area 548 may include a tip popup button 549, which may be clicked by user/trainee 27 to display tip information. Tip popup button 549 may be located in the lower left corner of work area 548 as shown, or may be located in the lower right corner, in the upper left corner, in the upper right corner, elsewhere in work area 548 or elsewhere in environment 300. Additionally, developer 26 may choose to have one tip popup button 549 as shown, more than one tip popup button 549, or no tip popup button 549. Step tree portion 520 of course editor screen 500 also includes an add/edit step button, which, when pressed, causes an add-edit pop-up window 550 (FIG. 9) to be displayed.

FIG. 9 depicts a screenshot of add-edit pop-up window 550 for creating and editing information about a particular step according to one embodiment of the invention. Add-edit pop-up window 550 includes step number display 552 that displays the number of the step currently being added or edited and step name field 554 that allows a step name to be entered. Add-edit pop-up window 550 also includes a step instruction field 556 that allows entry of resources that will be displayed to user/trainee 27 during the training course along with hyperlinks to other documents, web pages, or the terms glossary for that word.

Add-edit pop-up window 550 also includes a general tip field 558 that allows entry of resources that will display at the end of the step instruction in the training course, labeled as a tip. Also included in add-edit pop-up window 550 are a lo left tip button name 560 and lo right tip button name 562 that allow entry of a button title for tip popup button 549 in the lower left corner and lower right corner, respectively, of work area 548 (FIG. 8). Lo left tip popup 564 and lo right tip popup 566 allow for entry of the resource of the tip that is displayed when the lower left tip button and right tip button, respectively, are clicked by user/trainee 27. As stated previously, developer 26 may also enter information for additional tip popups, such as, for example an upper left tip popup, an upper right tip popup, a tip popup elsewhere in work area 548, or a tip popup elsewhere in environment 300. An A/V/M Clip browser 568 allows for selection of an audio, video, or multimedia clip with additional information to be played for user/trainee 27 in order to help user/trainee 27 understand what is going on at this point in the course.

Add-edit pop-up window 550 also includes an additional storyboard text area 570 that enables developer 26 to provide information that will be included in the storyboard document, but not directly in the training course. Additional storyboard text area 570 may include an interaction description field 572 for entry of a description of why this step is included, and what it does; a beginning image selector 574 for selecting an image that depicts what the trainee will see at the beginning of the step; and an ending image selector 576 for selecting an image that depicts what the trainee will see at the end of the step. Additionally, additional storyboard text area 570 may include an open issues table 580 that is a table list of all issues still unresolved about what should happen in this step. Open issues table 580 may include an issue description field 582, an issue status field 584, an issue date field 586, and an issue resolution field 588.

When developer 26 is satisfied that all of the information in add-edit pop-up window 550 is as it needs to be, and clicks a save 590 button, it will return the display back to course editor screen 500 (FIG. 8) for the highlighted or newly inserted step, where developer 26 can then edit or change the work area for this step, add other steps, or perform other functions related to the entire course. If, instead, developer 26 clicks a cancel 592 button, the entered information will not be saved.

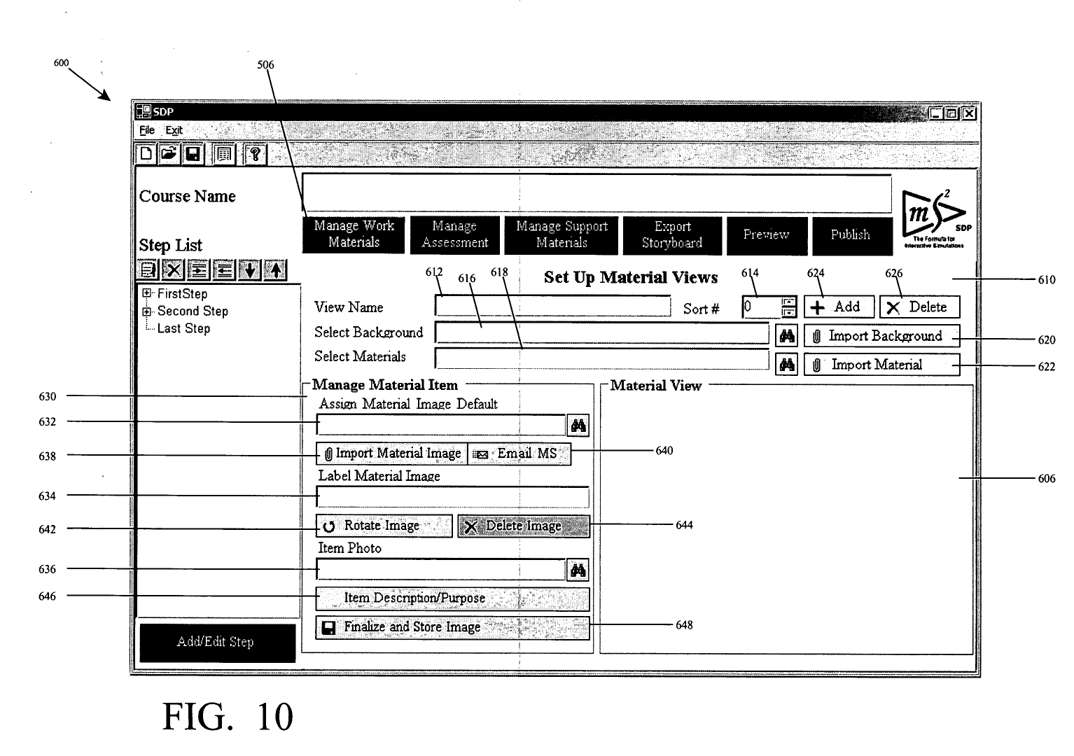

FIG. 10 depicts a screenshot of a material views screen 600 for creating and editing interactive objects 544A-I (FIG. 8) according to one embodiment of the invention. Material views screen is accessed by clicking on manage work materials button 506 of course editor screen 500 (FIG. 8). Material view screen 600 has a material view information area 610 for inputting information regarding object positioning area 542 (FIG. 8), a manage material item 630 area for inputting information regarding interactive objects 544A-I, and a material view preview area 606 for previewing object positioning area 542. Information that may be entered in material view information area includes view name 612, view sort order 614, background selection 616 and interactive object selection 618. Both background selection 616 and interactive object selection 618 may be imported from libraries 220 using an import background button 620 and import material button 622, respectively. Additionally, a view may be added using an add button 624 or deleted using a delete button 626. Information which may entered in manage material item area 630 include an assign material image default 632 that allows selection of a different default image that is to be displayed in work area 548, when interactive object 544 is selected from the materials view by user/trainee 27; a material image label 634 for displaying in a mouse over a tip box and in resource area 546, and an item photo selector 636 to provide an actual picture of the item, as opposed to the simulation drawings. Manage material item area 630 also includes several control buttons including buttons to import 638, email 640, rotate 642, delete 644, provide a description and purpose 646 and finalize and store 648 interactive object 544.

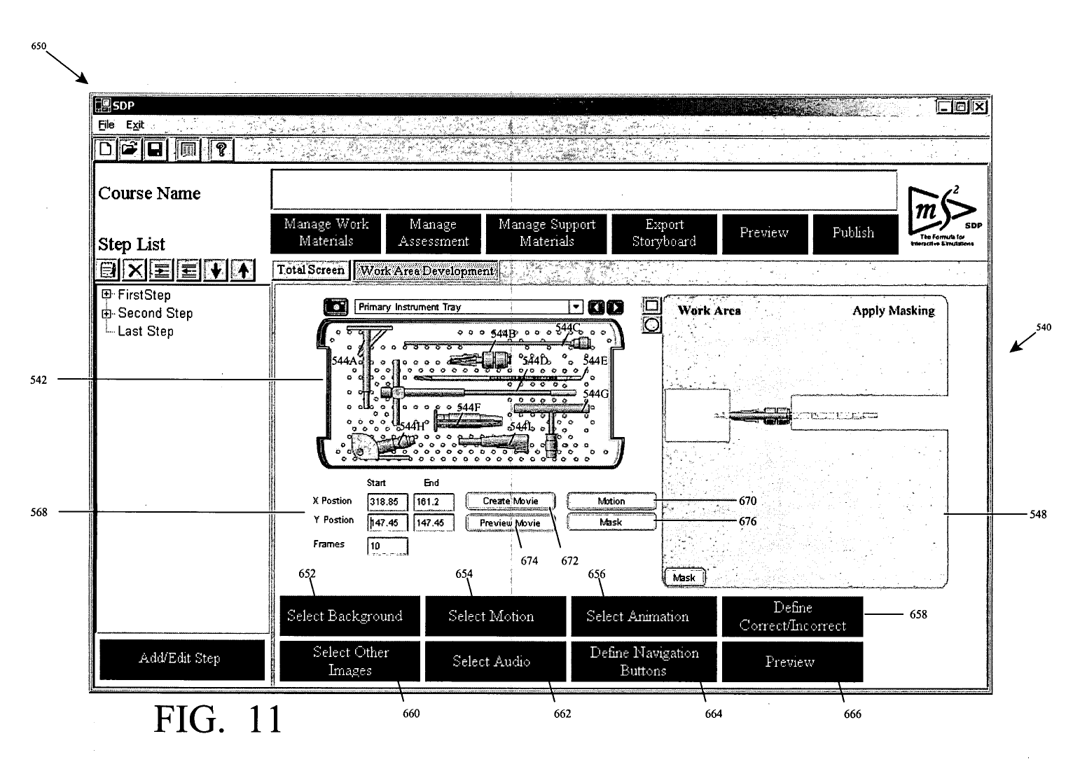

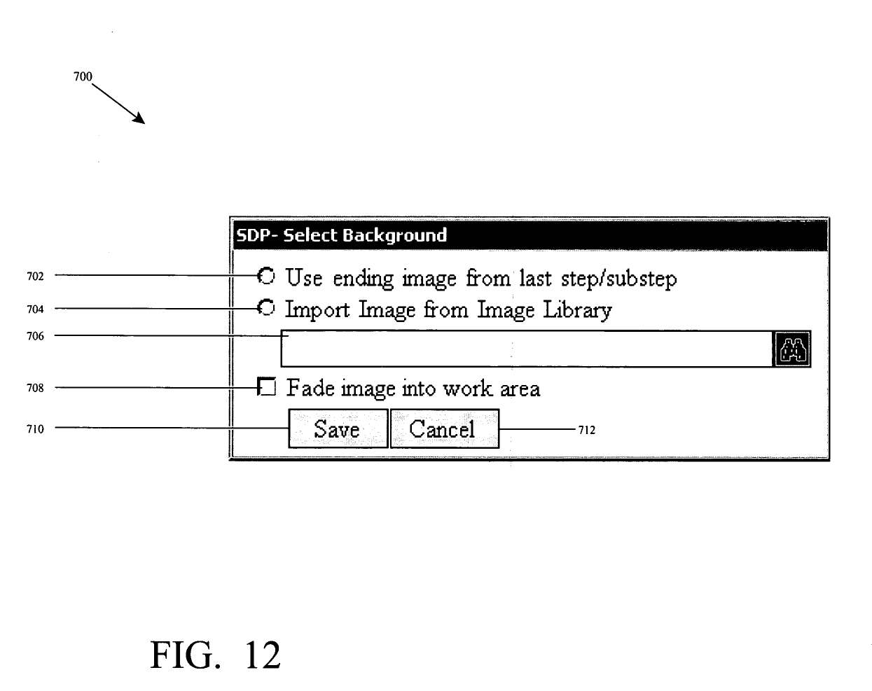

FIG. 11 depicts a screenshot of an environment development screen 650 for creating and editing environment 300 (FIG. 4) according to one embodiment of the invention. Work area development screen 650 includes several control buttons for creating or modifying environment 300, including a select background button 652, a select motion button 654, a select animation button 656, a define correct/incorrect button 658, a select other images button 660, a select audio button 662, a define navigation buttons 664, and a preview button 666. Select background button 652, when clicked, opens a select background question box 700 for use in creating and editing environment 300 according to one embodiment of the invention as shown in FIG. 12. Select background question box 700 allows selection of whether the ending image from the last step or substep is used 702 or, in the alternative, whether an image is to be imported 704 from image library 226 of libraries 220. If the image is to be imported 704, an image selection field 706 may be filled to provide the correct image. Select background question box 700 also contains a checkbox 708 for specifying whether an image is to be faded into environment 300. When developer 26 is finished with select background question box 700, a save button 710 may save changes to the work or a cancel button 712 may cancel without saving.

Also under the present invention, developer 26 can select one or more interactive objects 544 to be placed in object positioning area 542 or any other area of step creation areas 540. Interactive objects 544 can be added in many ways. For example, by clicking on select other images button 660, developer 26 can select an image from image library 226 (FIG. 3), using a popup. Alternatively, developer 26 can click on any interactive object 544 in any of material view created in material views screen 600 (FIG. 10), and the environment image for that interactive object 544 will be displayed in creation areas 540. A popup would then be displayed that enables developer 26 to use a different image from the default environment image for the selected material item, as it was defined in the materials views screen 600. Once an image is in creation areas 540, it can be highlighted, which puts it in the active mode. Developer 26 can then drag it to the position in environment 300 where it is to be placed when the trainee opens this step. The system will retain the coordinates of that place. In the alternative, developer 26 may enter x and y coordinates in x-y coordinates area 668. Developer 26 can then assign many different attributes to that image.

Select motion button 654 of environment development screen 650 allows developer 26 to assign one or more motions 670 to interactive object 544 (FIG. 8). Motions 670 may be created from scratch or may be imported from an external source, such as from motion library 228. Motions 670 may include, inter alia, rotate, with parameters such as clockwise/counter-clockwise, speed, etc; move, with parameters such as from where/to where, via what motion, etc; and click image spot, with parameters as to what to do when user clicks this spot, such as activate a keyboard key, or provide responses to the keyboard arrows, based on user pushing them, etc. Select animation button 656 allows developer 26 to assign one or more animations to interactive object 544, such as from animation library 228, for example, when developer 26 needs a very sophisticated, and reasonably lengthy animation for a single step. This also may be accomplished using a create movie button 672 to create an animation and a preview movie button 674 to preview the created animation. Developer may also select a mask for interactive object 544 by using a mask button 676. Select audio button 662 will allow developer 26 to browse audio library 232, and select an audio clip that will be played when the motion associated with the image is activated.

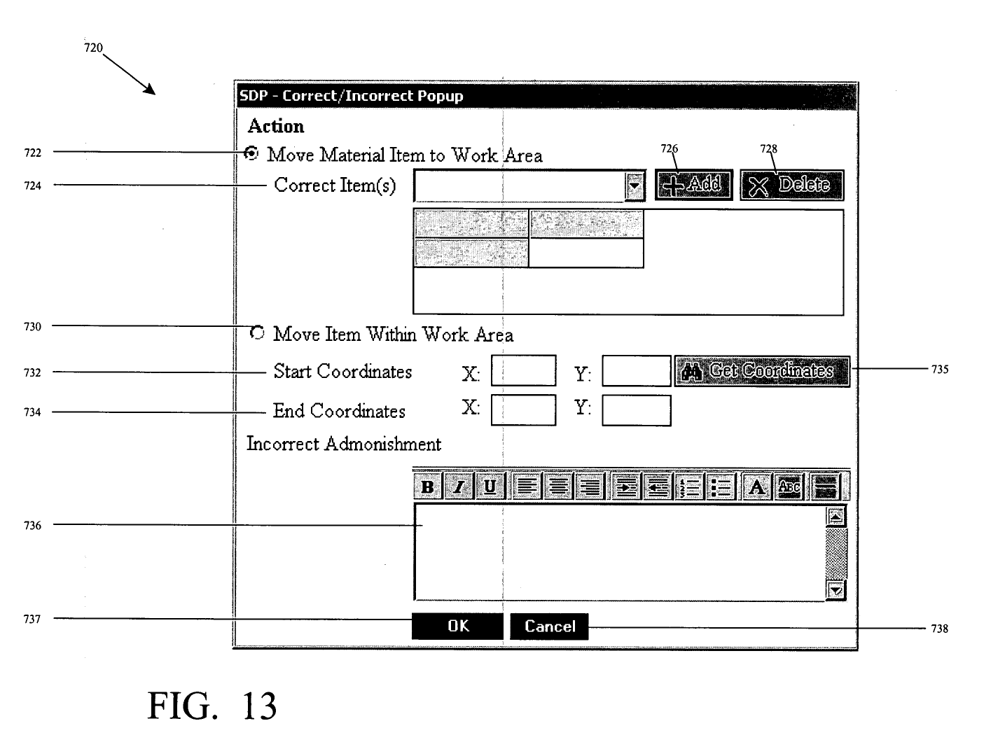

Define correct/incorrect button 658, when clicked, opens correct/incorrect popup screen 720 for creating and editing dialog of correct and incorrect responses according to one embodiment of the invention as shown in FIG. 13. Correct/incorrect popup screen 720 allows selection of whether to define interactive object 544 that is being chosen 722 by user/trainee 27 or moved 730 to work area 548. If interactive object 544 is being chosen 722, a correct items list 724 allows for addition 726 or deletion 728 of acceptable items for user/trainee 27 to use. If interactive object 544 is being moved 730 a set of start coordinates 732 and end coordinates 734 are specified, which signify the correct starting and ending coordinates for interactive object 544. Start coordinates 732 and end coordinates 734 may also be imported using a get coordinates button 735. An incorrect admonishment 736 may also be entered for display to user/trainee 27 that selects an incorrect response to the instructions. When developer 26 is finished with correct/incorrect popup screen 720, a save button 737 may save changes to the work or a cancel button 738 may cancel without saving.

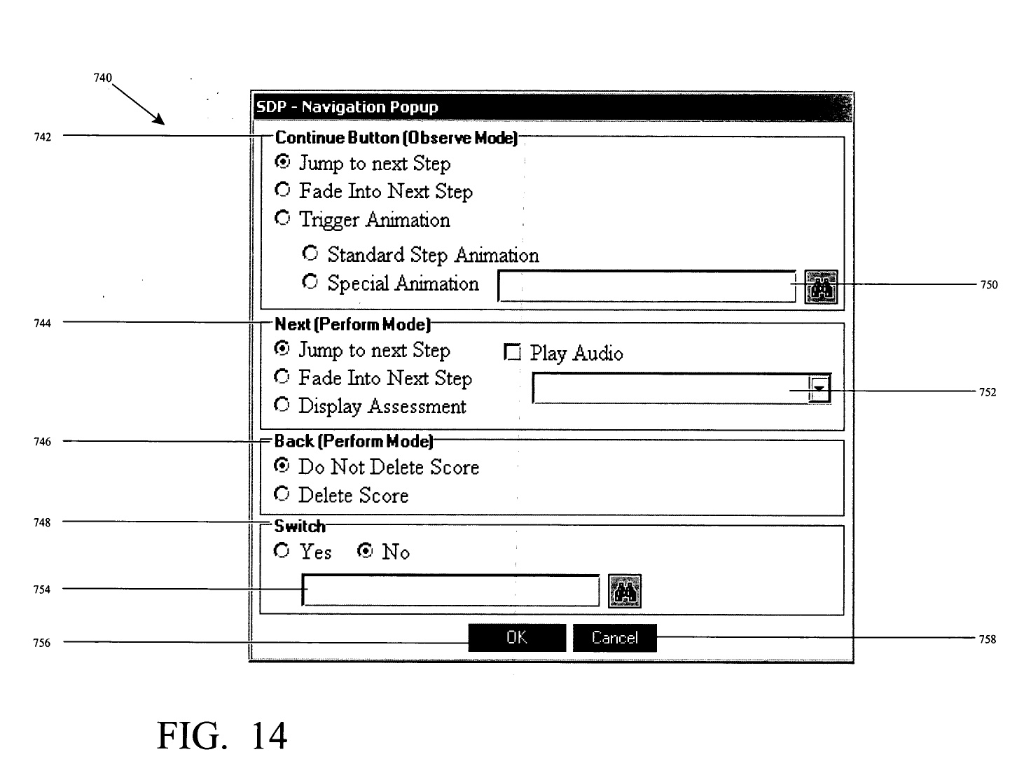

Define navigation buttons 658, when clicked, opens a navigation popup screen 740 for defining functions for navigation control buttons according to one embodiment of the invention as shown in FIG. 14. Navigation popup screen 740 has a continue button section 742, a next button section 744, back button section 746, and a switch section 748. Continue button section 742, which occurs in observe mode, allows selection of whether to jump to next step, fade into next step, or trigger animation. If trigger animation is chosen selection is allowed between standard step animation and special animation. If special animation is chosen, special animation field 750 allows selection of the source of the special animation file, including, but not limited to, animation library 230. Next button section 744, which occurs in perform mode, allows for selection of whether to jump to next step, fade into next step, or display assessment. Next button section 744 also allows for selection of whether or not to play audio. If audio is chosen, audio selection field 752 allows selection of the source of the audio, including, but not limited to, audio library 232. Back button section 746 allows for selection of whether to delete score or not. Switch section 748 allows for selection of yes or no. If yes is selected, switch selection field 754 allows developer 26 to specify to which interactive object 544 the screen should change when the button is clicked. When developer 26 is finished with navigation popup screen 740, a save button 756 may save changes to the work or a cancel button 758 may cancel without saving.

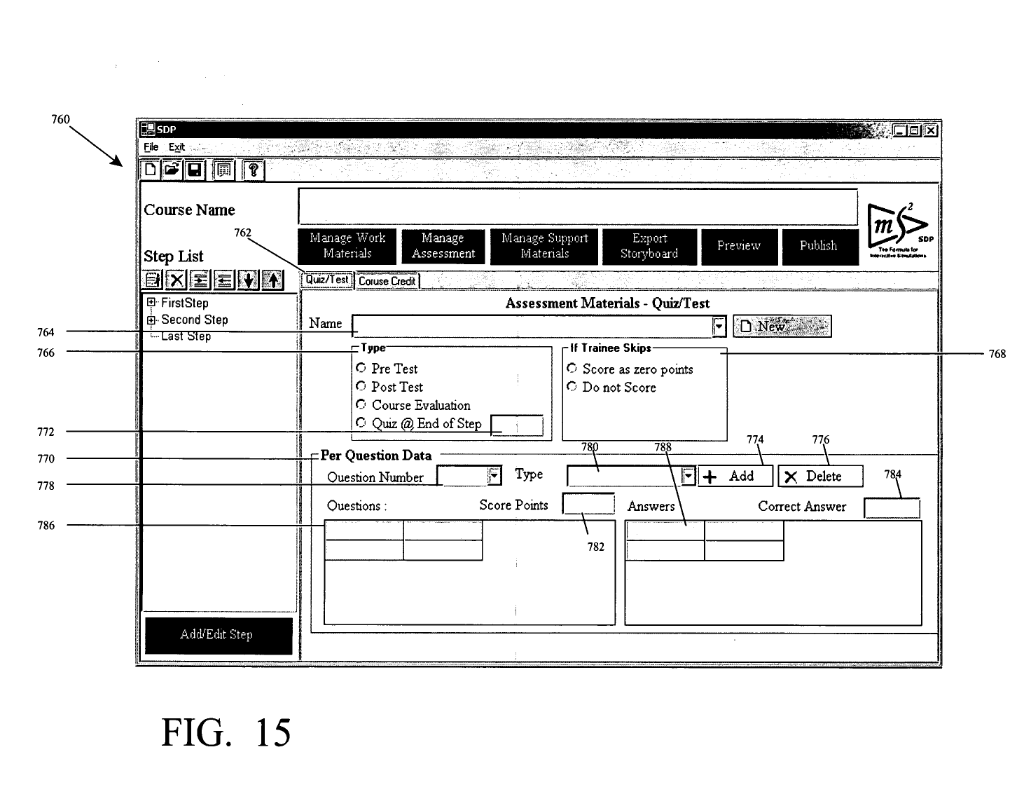

FIG. 15 depicts a screenshot of a quiz/test editor screen 760 for creating and editing quizzes and tests according to one embodiment of the invention. This screen is activated when manage assessment materials button 508 and quiz/test tab 762 are clicked. Quiz/test editor screen 760 includes a name 764, a type 766, a skip response 768, and a per question data table 770. Type 766 indicates the type of assessment and allows for selection among pre test, post test, course evaluation, and quiz at end of step. If quiz at end of step is chosen, step selection field 772 allows input of the quiz step after which the quiz will be given. Skip response 768 allows for selection between score as zero points and do not score. Developer 26 may also be allowed to enter the number of questions that the assessment tool is to use if, for instance, it is less than the total number of questions entered in per question data table 770. Per question data table 770 allows developer 26 to add 774 or delete 776 questions. To this end, developer is allowed to enter question number 778, question type 780 (including, for example, true/false, multiple choice, rating on a scale, action within a simulation, and comment), score points 782 to indicate how many points the question is worth, correct answer 784 for the question, text of question 786 and text of possible answers 788.

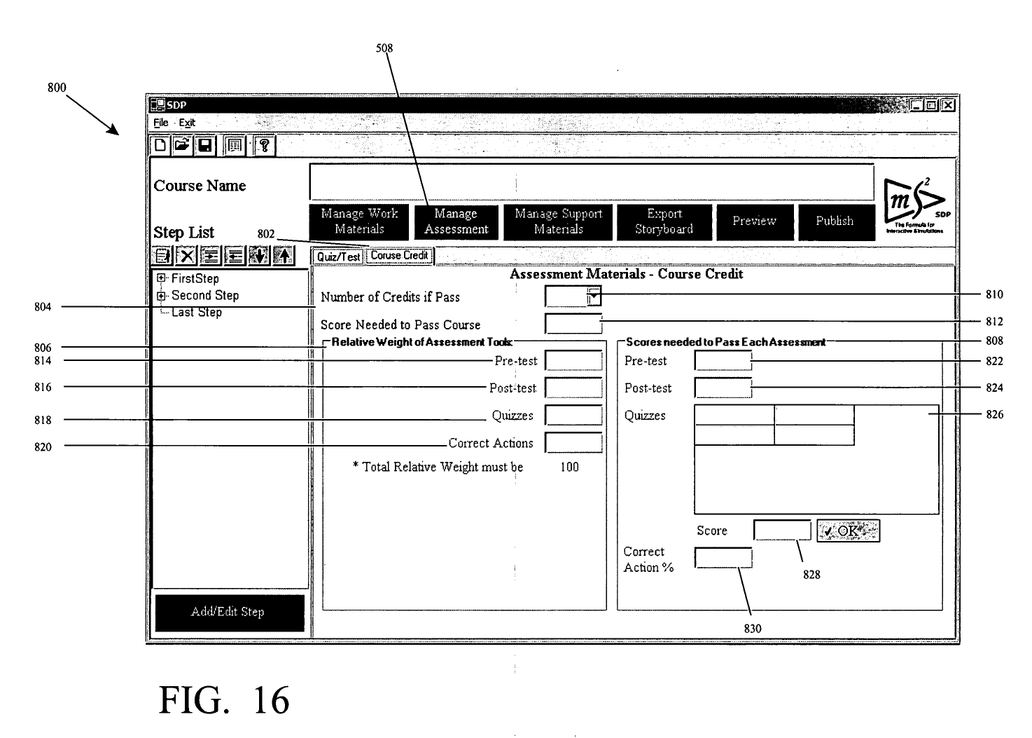

FIG. 16 depicts a screenshot of a course credit screen 800 for creating and editing a system for assessing credit according to one embodiment of the invention. Course credit screen 800 is activated when manage assessment materials button 508 and course credit tab 802 are clicked. Course credit screen 800 includes a general information section 804, a relative weight section 806 and a scores needed section 808. General information section 804 allows for entry of number of credits if pass field 810 to define the number of credits that this course generates for user/trainee 27 when completed successfully and score needed to pass course field 812 to indicate the score needed to pass the course and obtain these credits. Relative weight section 806 includes a pre-test weight field 814, a post-test weight field 816, a quizzes weight field 818, and a correct actions weight field 820 in which developer 26 may define the relative weight of the various assessment types in determining a total score. Scores needed section 808 allows developer 26 to specify whether the credits can be earned by just passing the post-test, or whether the entire course also must be completed and includes a pre-test score 822; a post-test score 824 for entering the minimum percentage of questions that must be answered correctly in the post-test and the weight to be given to the post-test results; a quizzes score table 826 for entering the minimum percentage of quiz questions that must be answered correctly and the weight to be given to the quiz percentage; a total score 828; and a correct action % field 830 for entering the minimum percentage of times the elected actions of user/trainee 27 in a simulation must be correct. When user/trainee 27 takes a quiz or test, this information will be stored, and after a course is completed, the pass/fail decision will be calculated and credit given user/trainee 27 if the appropriate minimum score has been earned.

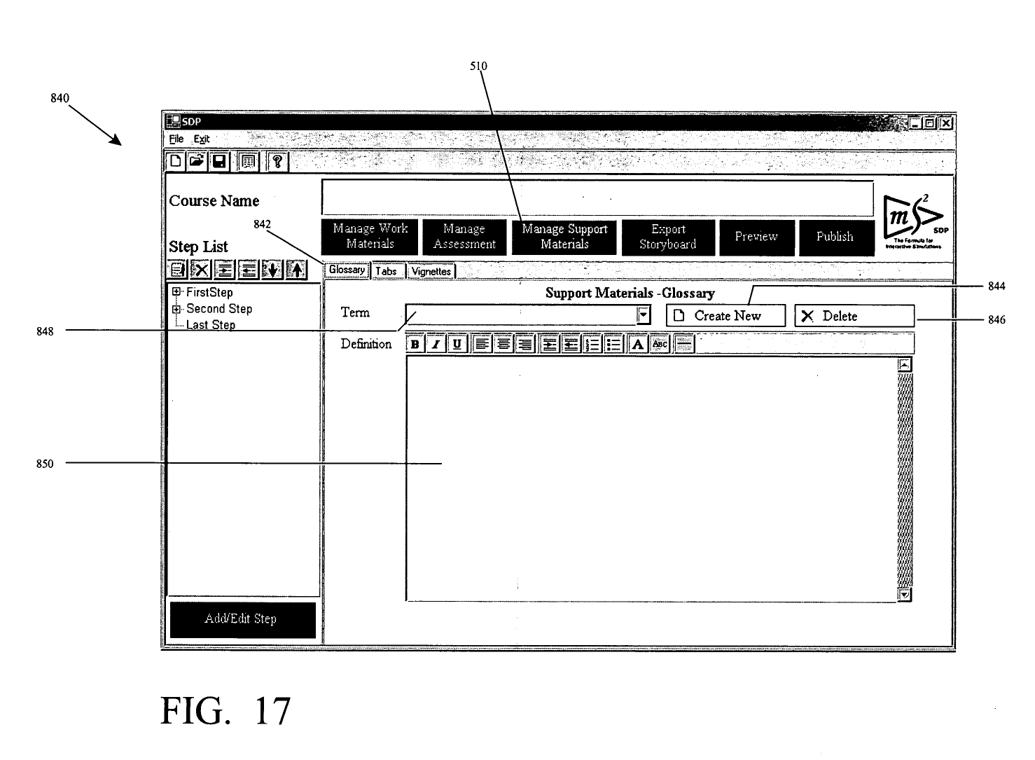

FIG. 17 depicts a screenshot of a glossary screen 840 for specifying glossary-type support materials according to one embodiment of the invention. Glossary screen 840 is activated when manage support materials button 510 and glossary tab 842 are clicked. Developer 26 may use glossary screen 840 to create a new 844 or delete 846 a term and includes a term field 848 for entering any word or set of words for which the developer wishes to provide additional information for the trainee to review and a definition field 850 for entering a definition of the term. Definition field 850 may also include hyperlinks that will open a browser window when clicked by the trainee.

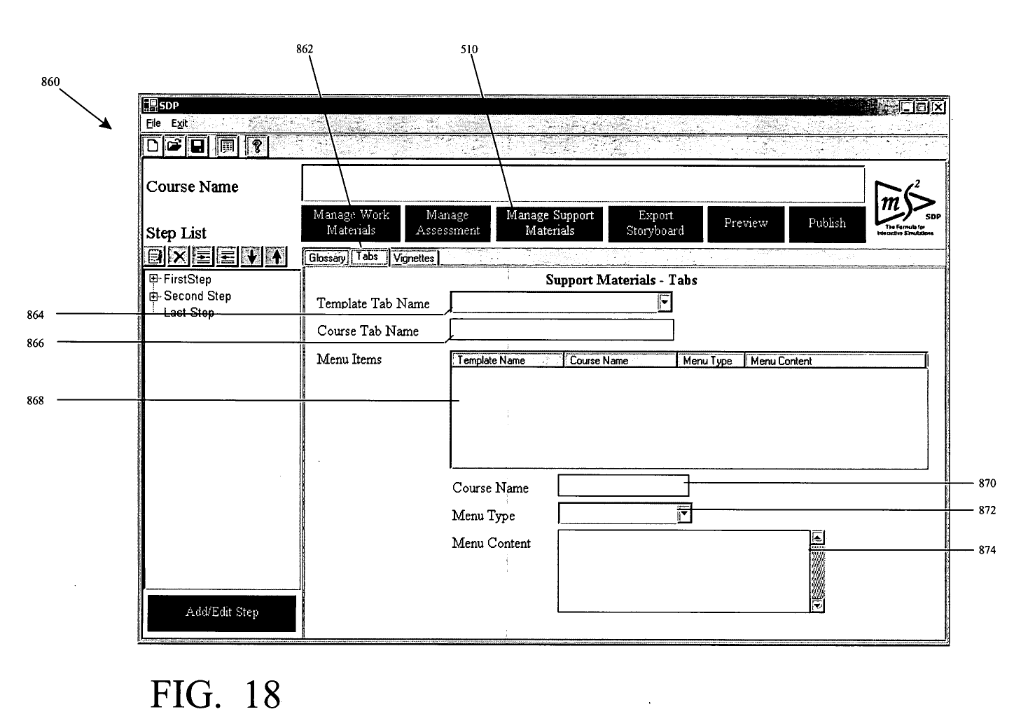

FIG. 18 depicts a screenshot of a tabs screen 860 for specifying tabs-type support materials according to one embodiment of the invention. Tabs screen 860 is activated when manage support materials button 510 and tabs tab 862 are clicked. Tabs screen 860 has a template tab name 864 that is a drop down of all of the tab names, if any, that are defined as part of the template for this course; a course tab name 866; a menu items table 868 that provides an editable line item for each menu popup item for that tab, as defined by the course template; a course name 870; a menu type 872; and a menu content 874. As stated above, menus may include, for example: an exit tab, a materials tab, an observe tab, a perform tab, an assessment tab, and an external file tab.

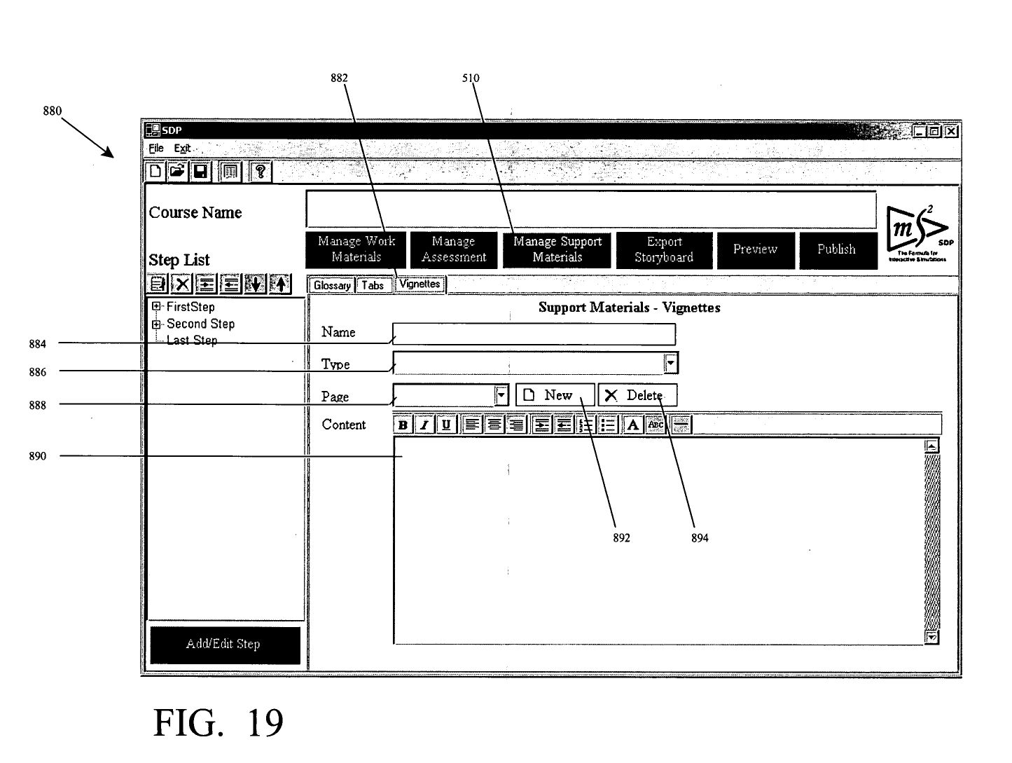

FIG. 19 depicts a screenshot of a vignettes screen 880 for specifying vignettes-type support materials according to one embodiment of the invention. Vignettes screen 880 is activated when manage support materials button 510 and vignettes tab 882 are clicked. Vignettes screen 880 allows for addition 892 or deletion 894 of a vignette and includes a name field 884 for entering the name to be given to this particular vignette; a type field 886 for entering the type of this vignette, which may include menu item, welcome, congratulations, or others as needed; a page field 888 for entering the page number for the content defined in the content area within the vignette; and a content field 890 for defining the content of each page. Content field may be in HTML or any other desired format.

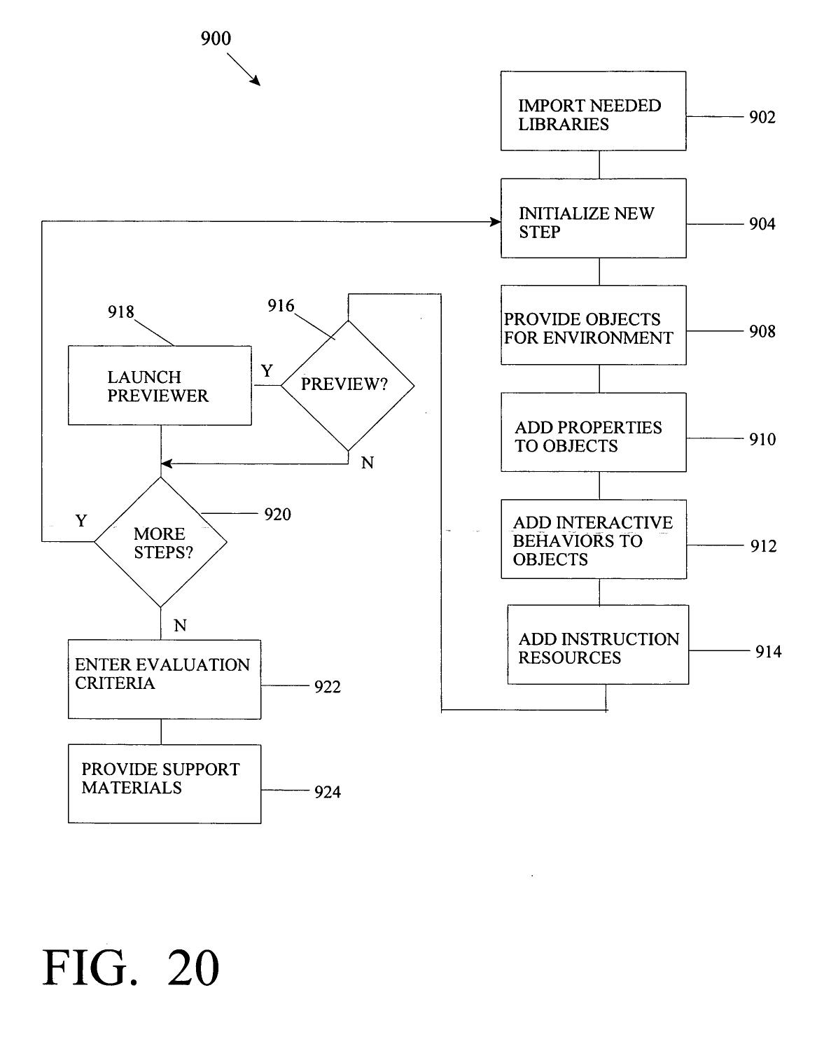

FIG. 20 depicts a method flow chart according to the present invention. First step 902 is to import needed libraries from libraries 220 using importer system 130. It is to be understood that libraries 220 may also be imported at any point in the method that they are needed. In step 904, a new step is initialized. This step may be performed using initializer 142 of interactive training course development system 120 (FIG. 2) and may utilize one or more windows, such as course editor screen 500 (FIG. 8), add-edit pop-up window 550 (FIG. 9), material views screen 600 (FIG. 10) and work area development screen 650 (FIG. 11).

In step 908 interactive objects 314 are provided for environment 300. This step may be performed using object provider 143 of interactive training course development system 120 (FIG. 2) and may utilize one or more windows, such as material views screen 600 (FIG. 10). In step 910, properties such as size, shape and color are added to interactive object 314, such as by using object property editor 144 of interactive training course development system 120 (FIG. 2) and utilizing one or more windows, such as material views screen 600 (FIG. 10). In step 912, interactive behaviors are added to interactive object 314. As stated above, these behaviors may include behavior when chosen, behavior when dropped, behavior when moved, behavior when rotated, behavior when used to operate upon another interactive object, behavior when used to operate upon an item in a work area, behavior when an action is performed successfully and behavior when an action is performed unsuccessfully. These behaviors may be added using object behavior editor 146 of interactive training course development system 120 (FIG. 2) and may utilize one or more windows, such as material views screen 600 (FIG. 10).

In step 914, instruction resources 334 (FIG. 3) are added to environment 300. As stated above instruction resources 334 may include instructions for performing a task, for example, by instructing user/trainee 27 to pick up interactive object 314 and to use interactive object 314 in a specific way to operate on or to manipulate item 334 in work area 330 of environment 300. Instruction resources 334 may be placed in environment 300 by resource editor 148 of interactive training course development system 120 (FIG. 2) and may utilize one or more windows, such as add-edit pop-up window 550 (FIG. 9).

In step 916, a decision must be made as to whether a preview is desired. If so, in step 918, previewer 150 of interactive training course development system 120 (FIG. 2) executes a portion of the training course for developer 26 to review. Execution then steps to step 920. If a preview is not desired, execution steps directly to step 920.

In step 920, a decision must be made as to whether there are any more steps to be created. If so, execution branches back to step 904 and a new step is initialized. If not, execution moves to step 922 in which evaluation criteria are entered. Evaluation criteria may be entered using evaluation system editor 160 and may utilize windows such as quiz/test editor screen 760 (FIG. 15) and course credit screen 800 (FIG. 16). Finally, in step 924 support materials are provided for use in the training program. Support materials may be provided using support materials system editor 170 and may utilize windows such as glossary screen 840 (FIG. 17), tabs screen 860 (FIG. 18) and vignettes screen 880 (FIG. 19).

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims. For example, interactive training course development system 120 is shown with a certain configuration of sub-systems for illustrative purposes only.

1. A system for developing interactive simulation-based training courses, the system comprising:
an initializer for initializing an environment for developing an interactive simulation-based training course;
an object provider for providing at least one interactive object for use in the environment;
an object property editor for editing a property of the at least one interactive object;
an object behavior editor for editing a behavior of the at least one interactive object; and
a training course resource editor for editing resources associated with the interactive simulation-based training course.

2. The system of claim 1, the interactive simulation-based training course having a plurality of steps, wherein at least one of the environment, the at least one interactive object and text in a first step differs from those in the second step.

3. The system of claim 1, further comprising an importer for importing a library resource.

4. The system of claim 3, wherein the library resource includes at least one of a course, a template, an image, a motion, an animation, an audio clip, a video clip and an action script.

5. The system of claim 1, wherein the property of the at least one interactive object includes at least one of size, shape and color.

6. The system of claim 1, wherein the behavior of the at least one interactive object includes at least one of behavior when chosen, behavior when dropped, behavior when moved, behavior when rotated, behavior when used to operate upon another interactive object, behavior when used to operate upon an item in a work area, behavior when an action is performed successfully and behavior when an action is performed unsuccessfully.

7. The system of claim 1, wherein the environment includes an object positioning area into which the object provider positions the at least one interactive object, a text area for displaying the resources and a work area for allowing a user to use an interactive object to perform a task.

8. The system of claim 7, wherein the resources includes instructions for performing the task.

9. The system of claim 7, wherein the user uses the at least one interactive object to operate on an item in the work area to perform the task.

10. The system of claim 1, further comprising a previewer for executing the interactive simulation-based training course.

11. The system of claim 1, further comprising an evaluation system editor for providing an evaluation system for allowing the interactive simulation-based training course to perform an evaluation of a user.

12. The system of claim 11, wherein the evaluation includes at least one of creating quizzes, creating tests, giving feedback, providing a grade and giving credit for completing the interactive simulation-based training course.

13. The system of claim 1, further comprising a support materials system editor for allowing the interactive simulation-based training course to provide support materials to a user.

14. The system of claim 1, wherein the supports materials include at least one of a glossary, tabs and vignettes.

15. A computer implemented method for developing interactive simulation-based training courses, the method comprising:
initializing an environment for developing an interactive simulation-based training course;
providing at least one interactive object to be placed in the environment;
editing a property of the at least one interactive object;
editing a behavior of the at least one interactive object; and
editing resources associated with the interactive simulation-based training course.

16. The method of claim 15, further comprising developing a plurality of steps, wherein at least one of the environment, the at least one interactive object and resources in a first step differs from those in the second step.

17. The method of claim 15, further comprising importing a library resource.

18. The method of claim 17, wherein the library resource includes at least one of a course, a template, an image, a motion, an animation, an audio clip, a video clip and an action script.

19. The method of claim 15, wherein the property of the at least one interactive object includes at least one of size, shape and color.

20. The method of claim 15, wherein the behavior of the at least one interactive object includes at least one of behavior when chosen, behavior when dropped, behavior when moved, behavior when rotated, behavior when used to operate upon another interactive object, behavior when used to operate upon an item in a work area, behavior when an action is performed successfully and behavior when an action is performed unsuccessfully.

21. The method of claim 15, wherein the environment includes an object positioning area into which the object provider positions the at least one interactive object, a text area for displaying the resources and a work area for allowing a user to use an interactive object to perform a task.

22. The method of claim 21, wherein the resources includes instructions for performing the task.

23. The method of claim 21, wherein the user uses the at least one interactive object to operate on an item in the work area to perform the task.

24. The method of claim 15, further comprising previewing the interactive simulation-based training course.

25. The method of claim 15, further comprising developing an evaluation of a user.

26. The method of claim 25, wherein the evaluation includes at least one of creating quizzes, creating tests, giving feedback, providing a grade and giving credit for completing the interactive simulation-based training course.

27. The method of claim 15, further comprising providing support materials to a user.

28. The method of claim 15, wherein the supports materials include at least one of a glossary, tabs and vignettes.

29. A program product for stored on a recordable medium for developing interactive simulation-based training courses, which when executed, comprises:
program code configured to initialize an environment for developing an interactive simulation-based training course;
program code configured to provide at least one interactive object for use in the environment;
program code configured to edit a property of the at least one interactive object;
program code configured to edit a behavior of the at least one interactive object; and
program code configured to edit text associated with the interactive simulation-based training course.

30. The program product of claim 29, further comprising program code configured to develop a plurality of steps, wherein at least one of the environment, the at least one interactive object and resources in a first step differs from those in the second step.

31. The program product of claim 29, further comprising program code configured to import a library resource.

32. The program product of claim 31, wherein the library resource includes at least one of a course, a template, an image, a motion, an animation, an audio clip, a video clip and an action script.

33. The program product of claim 29, wherein the property of the at least one interactive object includes at least one of size, shape and color.

34. The program product of claim 29, wherein the behavior of the at least one interactive object includes at least one of behavior when chosen, behavior when dropped, behavior when moved, behavior when rotated, behavior when used to operate upon another interactive object, behavior when used to operate upon an item in a work area, behavior when an action is performed successfully and behavior when an action is performed unsuccessfully.

35. The program product of claim 29, wherein the environment includes an object positioning area into which the object provider positions the at least one interactive object, a text area for displaying the resources and a work area for allowing a user to use an interactive object to perform a task.

36. The program product of claim 35, wherein the resources includes instructions for performing the task.

37. The program product of claim 35, wherein the user uses the at least one interactive object to operate on an item in the work area to perform the task.

38. The program product of claim 29, further comprising program code configured to preview the interactive simulation-based training course.

39. The program product of claim 29, further comprising program code configured to develop an evaluation of a user.

40. The program product of claim 39, wherein the evaluation includes at least one of creating quizzes, creating tests, giving feedback, providing a grade and giving credit for completing the interactive simulation-based training course.

41. The program product of claim 29, further comprising program code configured to provide support materials to a user.

42. The program product of claim 29, wherein the supports materials include at least one of a glossary, tabs and vignettes.

43. A method for deploying an application for developing interactive simulation-based training courses, comprising:
providing a computer infrastructure being operable to:
initialize an environment for developing an interactive simulation-based training course;
provide at least one interactive object for use in the environment;
edit a property of the at least one interactive object;
edit a behavior of the at least one interactive object; and
edit text associated with the interactive simulation-based training course.

44. Computer software embodied in a propagated signal for developing interactive simulation-based training courses, the computer software comprising instructions to cause a computer system to perform the following functions:
initialize an environment for developing an interactive simulation-based training course;
provide at least one interactive object for use in the environment;
edit a property of the at least one interactive object;
edit a behavior of the at least one interactive object; and
edit text associated with the interactive simulation-based training course.
